(19) United States
(12) Patent Application Publication
(10) Pub. No.: US 2002/0165630 A1
(43) Pub. Date: Nov. 7, 2002

(54) Method and apparatus for player lead tracking and playback of multi-player computer games

(76) Inventors: Penn Arthur, San Jose, CA (US); Maziar Farzam, San Francisco, CA (US)

Correspondence Address: John W. Carpenter, CROSBY, HEAFEY, ROACH & MAY, P.O. Box 7936, San Francisco, CA, 94120-7936, US

(21) Appl. No.: 10/136,748

(22) Filed: Apr. 30, 2002

Related U.S. Application Data
(60) Provisional application No. 60/287,854, filed on May 1, 2001.

(51) Int. Cl. G06F 155/00

(52) U.S. Cl. 700/91; 700/92

(57) ABSTRACT

A method and system for implementing custom made, multi-player computer games in a local area network, especially for corporate tradeshows, exhibits, presentations, museums, classrooms, etc., whereby enabling the game play, progress and players names and scores to be dynamically shown on a large video display device such a monitor cube wall or plasma displays. Player lead tracking information (name, address, etc.) is stored into a computer database prior to game play. Digital cameras are used by each player computer for capturing players' picture as an icon. Card scanners are used to automatically read contact and lead information directly into the game.

### BACKGROUND OF THE INVENTION

1. Field of Invention

The present invention generally relates to the collection of contact information and leads. The invention is particularly applicable to the tradeshow industry, promotional events and exhibits, and corporate promotions, conferences, or public and private corporate meetings where a marketing, promotional or activity utilizing kiosks, booths, or custom exhibit structures are utilized.

2. Discussion of Background

Computer multi-player games that take advantage of the Internet or Internet Protocol (IP) to communicate game play among all players are common today. These video games are usually either of the real-time 3D genre or sometimes called first-person point-of-view or shooters (such as Quake II and III, Manufactured by ID software, or Unreal Tournament manufactured by Epic Games) or of more 2D/3D, strategy type genre (such as StarCraft, and Diablo, manufactured by Blizzard Entertainment or Command and Conquer, manufactured by Westwood Studios). Common to all these games, is an on-line game server that is available via TCP/IP Internet communication protocols, set up by a game company, or individual users across the net. Individuals can log into these game servers and play with each other across a Local Area Network (LAN), Wide Area Network (WAN) or the Internet. Although these games have the common IP protocol based communication, they do not have the features and method of local public display and player lead tracking, as put forth in the present invention which directly applies to a local presentation of a game where an Internet connection may not be available, such as a trade show exhibit or corporate presentations.

Variety of video projection systems for presentation and public display of video or computer data content are available today. Among these systems are cube-based, rear-projection, video walls that use CRT or LCD-based video projections systems and are common in tradeshow and exhibit industry. In these systems, a series of 4×3 aspect ratio rear-projection type monitors are seamlessly assembled and connected next to each other to form a much larger image than each individual monitor. Recently, with the advent of gas plasma display technology, video walls can be created of series of plasma video displays as well.

Usually in the tradeshow industry, the attendees of a particular tradeshow are given electronic badges or cards that contain all their contact information, product interests and other pertinent information to the show on a magnetic strip or chip on the card. Badge scanners or reader machines are employed by exhibiting companies to scan the badges of attendees to their booth and store their information on a database or lead tracking software. Card or badge scanners such as these are designed, manufactured, and available as off the shelf (OTS) equipment.

Video digitization, compression, and playback technologies are popular today and employed to convert an analog video source data (from a VHS or Beta-SP tape) or a digital source (miniDV, Digital Beta, etc.) or other digital sources to an electronic, digital video file format (such as QuickTime or Video for Windows formats) that can be played back locally on a computer or across a network. The compression/decompression video technologies that are referred to a CODECs consist of software and hardware that allow a video signal to be captured, and then compressed so that extraneous and duplicate data is ignored or compressed, and decompress this data on the fly during video playback. Examples of such CODEC include MPEG-1, MPEG-2 or MPEG-4 formats that deployed for local playback from static media (CD-ROM, DVD, computer hard drive) or across the Internet.

### SUMMARY OF THE INVENTION

The present invention provides a local method and system for implementing and displaying custom multi-player computer games or interactive experiences via a Local Area Network (LAN) presented at tradeshows, corporate conferences and presentations, whereby enabling all players names, score, real-time, ongoing game play to be displayed locally on large video display devices.

The present invention also provides a method and system for locally capturing, organizing and storing each players contact information as provided by players into the input screens or via an automatic badge card reader attached to each player's game CPU.

The present invention includes a method and system for TCP/IP based networking and connecting the main server CPU and all player CPUs among themselves and to large display devices, providing for intelligent triggering of the game play when players are connected.

The present invention also provides a method and system for playing back of in-between, looping animation or video files at highest resolution possible across a LAN between each round of game play on the large video display devices.

The present invention utilizes a digital camera connected to each player computer to capture their photo and use it as a player's game piece icon, and also as texture maps inside the game and show it also next to the winner's name at the end of the game. The main and user computing devices could include a desktop, laptop, palmtop, or any other hand-held, portable or static computing device.

Both the methods and systems of the present invention may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s) etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of the general hardware and software systems setup used for carrying out the present invention.

FIG. 2 is a schematic showing the display-type connections of the player and main CPU to a large video display or video wall system, with a capability to dynamically switch from player screens output to the main server CPU output.

FIG. 3 is a flow chart for the player game executable application logic for interacting with main CPU and other players for game play start to finish sequence.

FIG. 4 is a flow chart for the main game executable application logic for interacting with other players for game play start to finish sequence.

FIG. 5 is a schematic of the player lead-tracking and contact information storage to a local or remote database file via integrated game digital input forms or automatic card scanner.

FIG. 6 is a schematic showing the integration of digital cameras into game play for capturing player pictures and storing the images as player icons and game texture maps.

FIG. 7 is a schematic showing the video or custom animation storage, playback and timing between each round of game play.

### DESCRIPTION OF THE PREFERRED EMBODIMENTS

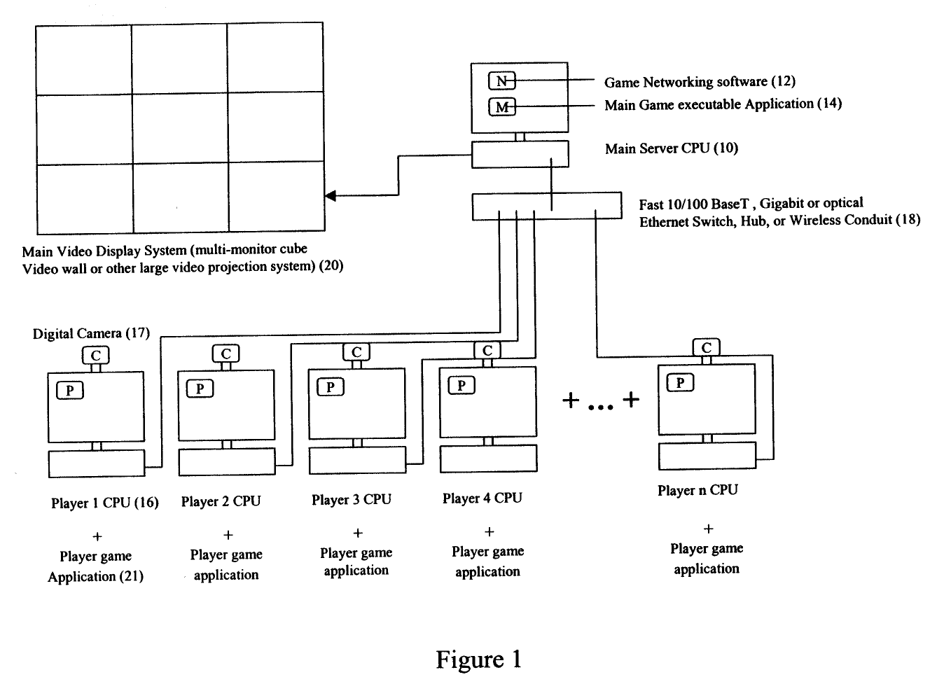

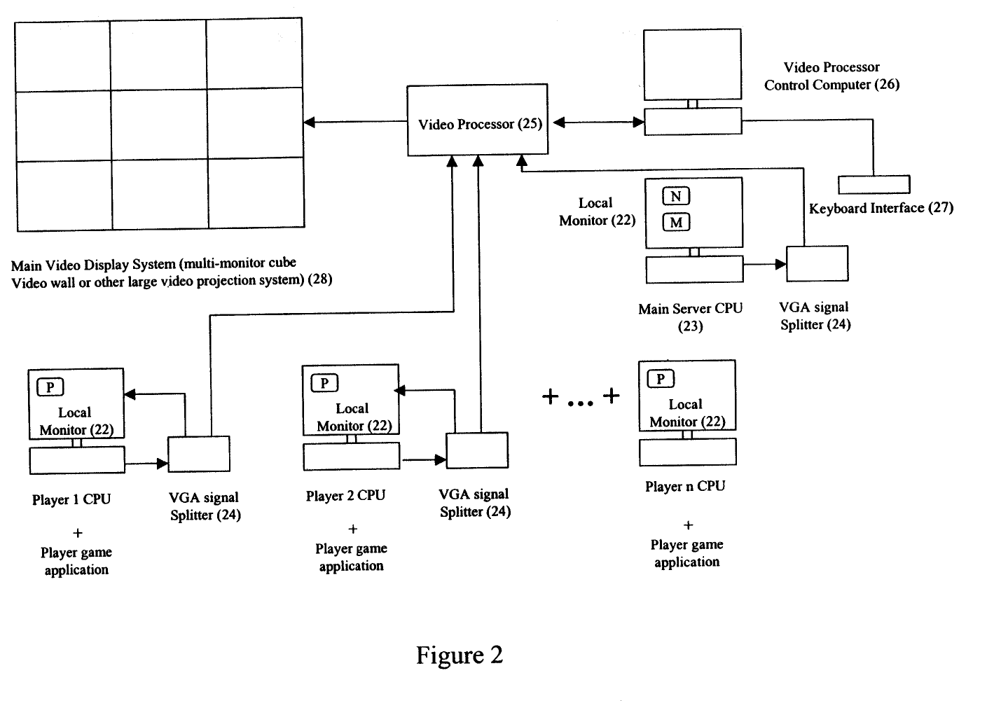

Referring now to the drawings, wherein like reference numerals designate identical or corresponding parts, and more particularly to FIG. 1 and FIG. 2 thereof, there is illustrated a set of custom game setup arrangements.

Each custom game setup arrangement consists of a main computer server or main server CPU 10 that hosts the game networking software 12 (For example, Macromedia's multi-user Server, RTIME™ Interactive Networking Engine, or other game networking/communication server software that preferably enables realtime, multiuser applications over the Internet or other broadband networks.) and main game executable application 14. The main computer server may be connected and networked via TCP/IP networking protocols to all players CPUs 16, using an Ethernet 10/100 BaseT, Gigabit, or optical fast switch, hub, or wireless conduit 18.

Each player CPU has a player game application 21 and a digital camera 17 may be connected via a Universal Serial Bus (USB) or similar connection. Generally, for custom multi-player games, the main server CPU and all player CPUs (player CPU 1 to Player CPU n) are all networked and can communicate with each other before the networking software 12 and main game executable application are launched. The main server CPU is connected to a large video display device 20, that could consist of multi-monitor cube video wall or other large video projection system. Generally, the networking software 12 is setup to detect the correct IP address of the server CPU and be running before the main game executable application is launched.

Referring to FIG. 2, each player CPU is connected to a local monitor 22, via a VGA splitter box 24, that splits the VGA signal from the video card of the CPU and sends the game play video signal from the player CPU to the local monitor 22 and to a video processor 25. The main server CPU 23 is also connected to its own VGA splitter box 24, which is connected to the main server CPU's local monitor 22 and to the video processor 25. Associated with the video processor 25, is a video processor control computer 26 that is used to control and direct the VGA output from the main server CPU and all player CPUs to a video projection system 28.

A keyboard interface controller 27 allows a user to dynamically switch the content displayed on each video display monitor (or the each individual cube wall monitor). For example, a game host, hostess or moderator can press an assigned function key on the keyboard controller 27 and show the game play video content that is being displayed from player 1 onto the video display 1, or from player 2 into video display 2, etc. or switch all cubes to show the VGA output from the main server CPU. Similarly, a computer controller application stored on main server CPU can send a signal to switch the content displayed on the video display monitor(s). Other options also include display of video from a selected player's view (output) of the game on all the cubes, and interspacing advertising video on a single cube or intermittently flashing between ads and game play on all cubes, for example. Video processor 25 is connected to the video projection system 28 which is, for example, capable of displaying VGA (640×480 pixels) or higher resolution, up to current or future HDTV standards (1024×1024 pixels or higher).

This video projection system 28 can consist of any video projection system, in particular, rear-projection, individual 3×4 or 16×9 aspect ratio video cubes that together create a cube-based video wall (these can be in combinations of 2×2, 3×3, 4×4, etc. individual cubes that create a much larger image). Such video cube walls are available through companies such as Toshiba and Sony. Other large-screen video, front or rear projection systems that employ Cathode Ray Tube (CRT), Liquid Crystal Display (LCD), or Digital Light Processing (DLP) projection (as provided by companies such as Barco, Runco, Sony, Sharp, Vidikron, etc.) or combination of these together along with plasma or other LCD based video displays of various sizes and resolutions (as provided by companies such as Sony, NEC, Fujitsu, etc.) can be used for public display of the game play content from the main game executable application and player game executable application. Furthermore, new LCD-based video projection systems that take advantage of Digital Light Processing (DLP) technology can be utilized to project larger and brighter images than traditional LCD-based projectors. In addition, new Digital Theater or Digital Cinema projection technologies as offered by Texas Instrument's DLP Cinema and Kodak's Digital Theatre system can be used to provide the highest, film-quality resolution (1280×1024 pixels and 2048×1536 pixels) for display of game content.

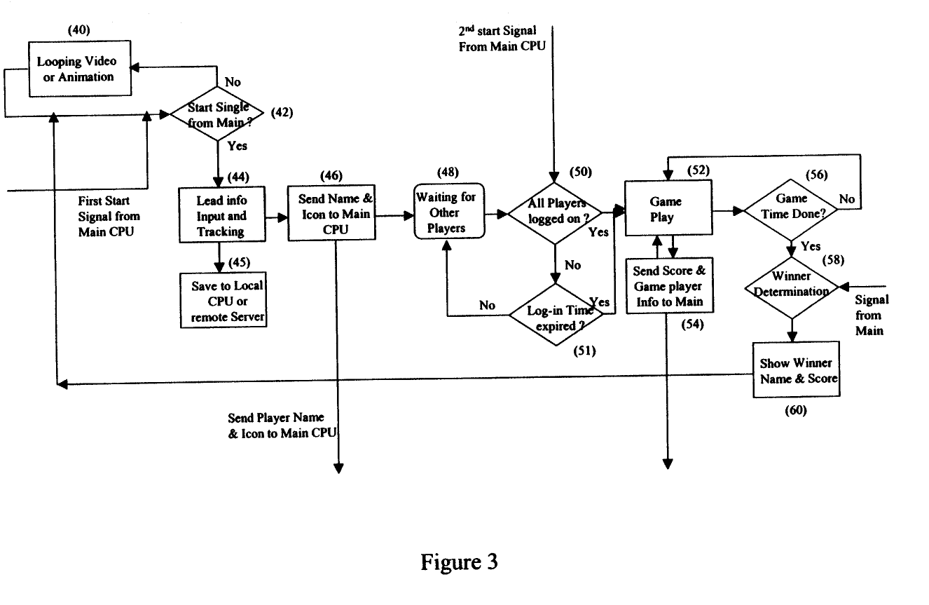

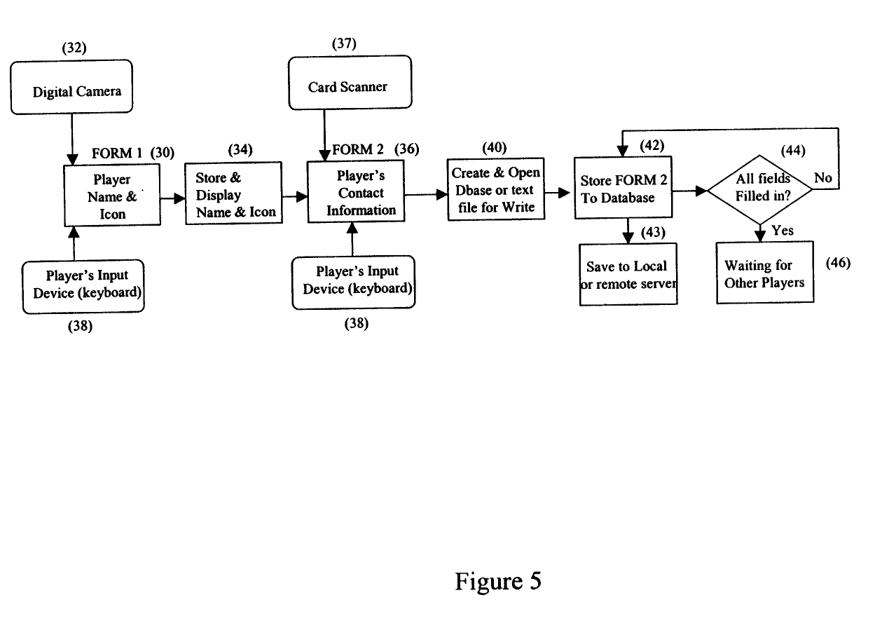

Referring now to FIG. 3, each player CPU has accesses to a stored player game executable application that runs on each player computer. Preferably, each player game executable is launched after both the game networking application and main game executable application have been launched. Once the player executable application is launched, a custom digital video or animation plays in a loop (block 40) and is displayed on the local player monitor (FIG. 2) till a signal from the main server triggers the start of the game (block 42). The player game executable then advances to a lead tracking form (block 44), which is either manually filled by each player or filled automatically by scanning their badges via an infrared or magnetic based card reader (As shown in FIG. 5). The lead tracking data is then saved. For example, the player game application creates a text file on the local hard drive with read/write privilege and then writes the lead tracking data to it, in a tab or comma-delimited format (block 45). The lead tracking data may also be sent to the main server for storage or saved to a remote server. Player game application will then send the first name and last name initial (or other nickname entered by the player) from an entry form and player icon graphic selected by the player to the main game application (block 46). Player game application will then enter a “waiting for other players” loop (block 48) and stays there either till a signal from main application (block 50) is received that states that all players have logged in and have filled their entry forms or the log-in time has expired (e.g., block 51). The player executable will then advance to the game play (block 52). Here the player will engage in the custom game play designed. During the game play, each player executable application will send a player's score, player's location or state in the game, etc. for the player corresponding to the player executable application to the main application (block 54).

In one embodiment, a game timer is programmed to the desired length of each game and the player application will track of the time and check to see if the timer has ran out (block 56). Once the timer runs out, the player application will enter a winning determination loop (block 58) and will wait till the main application sends a signal with the name and score of the winner. Player application will then show the name and score of the player (block 60) and loop back to the opening digital video or animation.

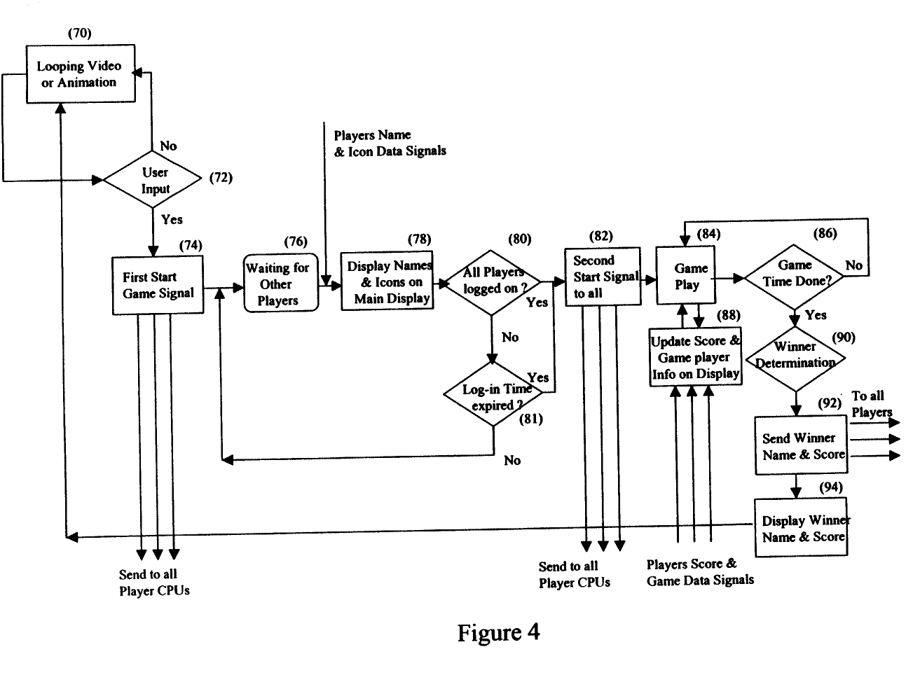

FIG. 4 is the block diagram of how the main game executable application interacts and communicates with all player executable applications. The main game application can also incorporate the same looping animation as the player game application (block 70). The main application can be triggered to start the game (block 72), via a user input (mouse or keyboard) that will send the first start signal to all player game applications (block 74) (Alternatively, the main application is triggered via a predetermined schedule, e.g. every 20 months, etc.). The main application will then enter a waiting loop (block 76) where it awaits receiving signals that include player names and player icons from all player applications. Upon receiving a name and icon data from a player executable, the main application will display this data on the designated player location on a main scoreboard graphic (block 78). This scoreboard is displayed and updated continually on the main video display during game. When the main application detects that all players have logged on (block 80) or the log-in time has expired (block 81), either an automatic signal is sent to all players or the game host or hostess presses a “start” button on the main application graphical interface that sends a second start signal to all player applications (block 82) and enters into the game play loop (block 84). During the game play loop, main application constantly checks to see if the timer has ran out (block 86) and checks for updated score, location data or other player data that is sent from player executables (block 88) and posts these updates to the main scoreboard automatically. If the timer runs out, main application enters winner determination (block 90) and will pick the highest score (or shortest time or whatever the winning criteria is) and will send the player's name and winning data to all players (block 92) and will display who the winner is (block 94). In one alternative, the game continues until a predetermined event (e.g. flag capture, finish line, opponents neutralized, etc.) occurs, then the winner determination block announces/displays the winner.

FIG. 5 is a block diagram of an example of how the player game application allows for player information, lead capture and contact management data storage into a local or remote database. After the player game application receives a signal from the main, the first digital input form will come up where the player enters his or her name and selects a graphic or icon that will represent them during the game as a player icon (block 30). As an alternative, the player may be able to see a continuous video feed from a digital camera connected to their player CPU (block 32). Players will be able to take a photograph of themselves by clicking a button on the graphical interface. When the player clicks the “next” button on the graphical interface, player name and icon will be saved and displayed locally on the game interface (block 34). The player application will then proceed to input form 2 (block 36), which can be a contact information form (name, address, phone number, etc.). The data fields in this form can either be filled manually by the user via the computer keyboard (block 38) or filled automatically by using a card or badge scanner (block 37). Electronic card scanners that use infrared or magnetic readout technology can be interfaced via RS232 serial interface, USB or other connection to the player CPU and computer code is written to dump the scanned information from players tradeshow badge card directly into the form's empty fields. The player application then checks to see if all the necessary fields are filled. If they are not, it will prompt the player to fill in all the necessary fields. If all the required fields are filled, it creates and names a new database file (block 40), for example in simple-text file format based on the player CPU number with a sequential numerical index for each new file created (for example, player11-03.txt will be created for the 3^{rd} sequential file on player 11 machine). It then opens this database for read/write, writes the system date and time and stores each field of form 2 into this file followed by a <TAB> or comma ASCII character (block 42). Once it finishes the last field of input form 2, the player application saves and closes the data file. If all the required fields are not filled in form 2, program will prompt the user and stays in form 2 (block 44). The application will then advance to the next input form (if any) and the user selects or fills the necessary information and the application will append and save this data to the data file that was just created. This cycle continues for any additional data forms in the game (repeat of block 36 to 44), then program advances to the “waiting for other players” loop (block 46). Many different methods may be envisioned for collecting player data and game playing preferences. The important aspect is that the valuable contact information such as the players name and address (e.g. company address or e-mail) is collected. Alternatively, without the player contact information, the player may not be accepted for game play, or the player may be subject to additional advertising or other questions (e.g. a product survey or evaluation) before being allowed to game play.

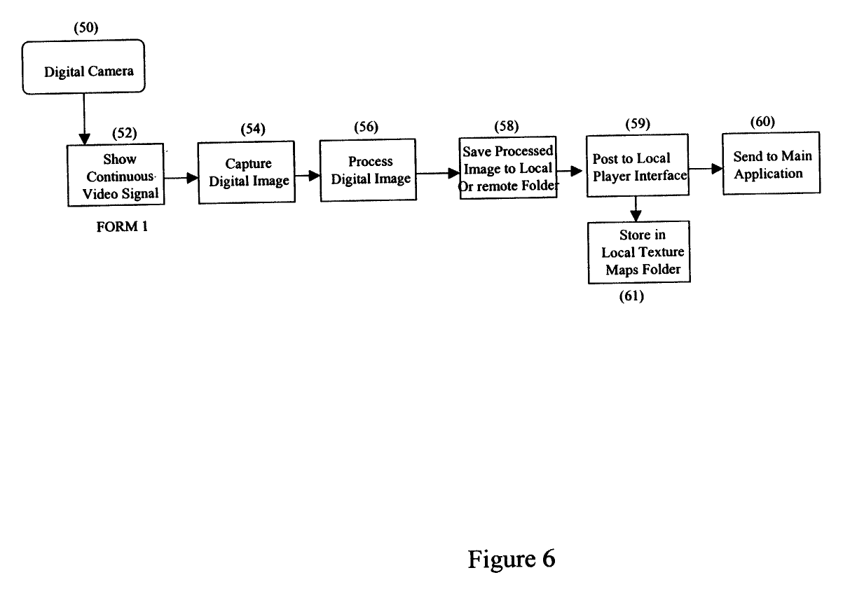

FIG. 6 is a method of integrating a digital video or still camera (block 50) into each player CPU. The graphical interface in player executable application will show a continuous feed from the digital camera into a video window (block 52) in form 1 of the player lead capture as described in FIG. 5. User can pose in front of the camera and click a “Take Photo” button on the game interface that will take and store an individual frame on the local player hard drive (block 54). The player game application will then process this image, reduce its size and resolution to accommodate game and in-game graphic requirements (block 56) and save this as JPEG or other digital image format to a local folder (block 58). Player game application will post this image into the local player interface during game play (block 59), and also send this file to the main game application (block 60) which will be displayed on the main scoreboard as explained by FIG. 4. In one embodiment, especially well suited for real-time 3D type games, the player image is stored into a game texture folder (block 61) and can be read by the player application dynamically and applied to texture maps in the game, for example billboards in a virtual 3D city, framed pictures on a wall inside a 3D house, face of their in-game character or icon, or used in other graphics or animations in the game or during pre/post game animations.

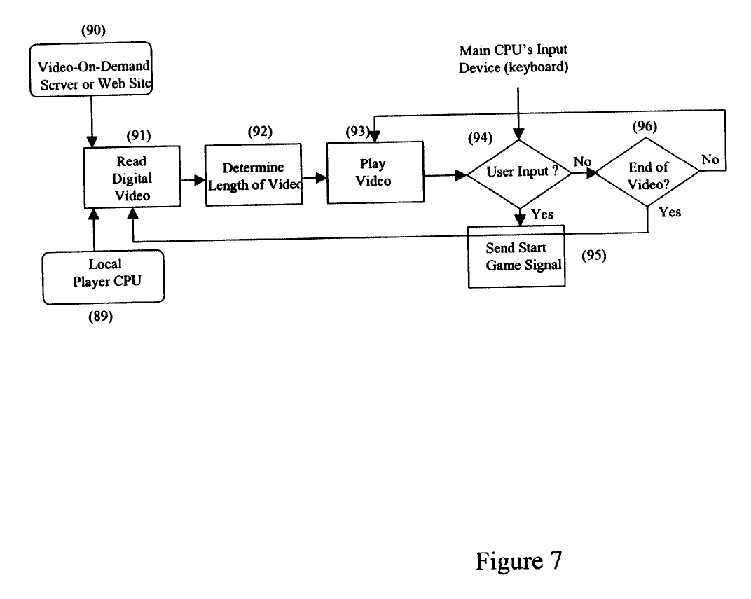

FIG. 7 demonstrates that a custom digital video or animation file is read (block 91) by both main and player applications from a local hard drive (block 89) or Video-On-Demand (VOD) or web server remote to the gaming network (block 90). Total length of the video (in seconds) is determined (block 92) and video decompression and playback is initiated via the game and player application using the appropriate CODECs installed on each system (block 93). During playback, the main game application will check to see if there has been a signal from user input device (keyboard or mouse), and on the player game application, it checks to see if there has been a signal from main (block 94). If there has been a signal, the application will start the game play (block 95), if not, the application checks to see if the end of video has reached. If it has, it will go to the beginning of the video and start playback again (block 93).

Then, in summary, without limiting the invention, in one embodiment, the present invention provides a method and system for implementing custom made, multi-player computer games in a local area network, especially for corporate tradeshows, exhibits, presentations, museum exhibits, or classroom and learning environments, etc., whereby enabling the game play, progress and players names and scores to be dynamically shown on a large video display device such a monitor cube wall or plasma displays. In other embodiments, the invention is a method that includes networking player computers to a main game server via a TCP/IP protocol and assigning the IP address of the main game server to the player machines via a password-protected screen, integrating player key lead tracking information (name, address, etc.) dynamically into a computer database prior to game play, controlling game playback using the main game server computer, triggering data communications between player computers and the main server such as transmission of player information (name, player icon, score, location in the game, etc.) and winner determination. In yet other embodiments. the method of invention also includes interfacing certain hardware to the games such as digital cameras to each player computer for capturing their picture as an icon, badge or card scanners for automatically reading contact and lead information directly into the game, and video projection systems for displaying the score board and on-going networked game play.

In other embodiments, the same method of implementing and public display of multiplayer games in a local area network can be applied to interactive movies shown in a theatre or a museum. In this setting, each attendee has a computing device, which is networked to a main computing device. At particular branching points during the movie or the museum presentation, attendees get to enter their votes or answers to a particular question, which is then tallied by the main computer. The main computer will then decides based on the majority of the votes, what direction the movie is going to take next or what part of the presentation is going to be displayed on the main projection display.

In yet another embodiment, the method presented in this invention can be used in a classroom environment for collaborative learning, e-learning and/or remote learning. A game-like scenario, or a learning project can be given to a group of students, each with their own computing device, networked to a main server computer. The main server will display the assignment or problem on a main screen, and give students the instructions or lessons necessary to know before solving that problem. Students log their name and information before start of this educational, multi-player game.

Students can either work together in groups trying to solve this problem (math, sciences, social studies, languages, etc.) or compete on individual bases to log their answers.

In one embodiment, the game is interleaved with and supports the lesson plan to be achieved. For example, in an Egyptian history lesson plan, players will need, for example, to learn lessons regarding the pharaohs, mummies, and pyramid building. Each lesson comprises a set of tasks that must be completed. Each task is performed in a different room or learning cell. The rooms or learning cells might be, for example, rooms of a pyramid or maze. Tasks for example, might be to learn things like the economic or social system of the pharaohs, answer questions like who were the 5 most important pharaohs, or who was the first pharaoh. Answering the questions correctly allows the player to advance to another level (move to the next room), or give the player more energy, health, or ammo depending on the game format. If a student is unable to answer enough of the questions, a study routine is invoked where the game play discusses aspects of ancient Egypt and the Pharaohs. The player then tries again to advance.

The individual players continue to player at their own level. Advancement through each task is performed by each player on their individual computing platform, which may be a desktop computer, laptop, palm pilot (palm sized computer), or a cell phone having appropriate wireless connections to the main server. How all the players fit together is shown on the main screen. For example, the main screen may show a maze (or pyramid) proliferated with Egyptian icons and each player is displayed at a location in the maze (or level of the pyramid). Finally, a player that completes the lesson plan moves on to other studies or perhaps gets started on the next lesson plan.

In another example, a health sciences lesson plan, players may be shown on the main screen in a particular portion of the body. Players working on tasks for cartilage and joint study are displayed in the knees, players studying tasks for bacterial infection such as ecoli are shown in the intestines, those studying heart problems are in the chest, and those studying brain functions are shown in the head. Each area studied is tied in to the lesson plan. Each task is learned in an interactive learning environment preferably in a game setting.

For example, while learning about fighting infections, the students will be attempting to collect enough ammo to destroy the ecoli invaders. Once enough ammo is collected by answering questions like “where does ecoli come from ?”, and how does one get infected with ecoli?,” then the ammo is used in a game like fashion to kill the ecoli. If ammo is running out, the user may be queried a bonus question to extend life or add more ammo to the players chosen weapon.

The present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, dynamically switching multiple display views (including, but not limited to, user and main display views) to one or more output displays, synchronizing start and user data entry to multi-player programs, collecting and storing player lead data, capturing images of the players for use in icons and scoreboard displays, and the display, storage, or communication of results according to the processes of the present invention.

The following paragraphs provide some example non-limiting descriptions of specific embodiments and/or components of the present invention.

A method of public displaying custom multi-player computer games, comprising, (a) Connecting a main computer server (CPU) to a local monitor and to a main video processor via a VGA signal splitter, (b) Connecting each of individual player computers to a local monitor and to the main video processor via a VGA signal splitter (c) Connecting the main computer server to a processor control computer which controls the switching of the video wall between server computer VGA output and individual player computer VGA outputs, (d) Connecting the processor control computer to the main video processor via a RS232 connection, and (e) Said step (a) and (b) comprises of connecting the main video processor to a multi-cube video wall, plasma display wall or other large video display device, via a component video output (RGB), VGA or S-video connections.

The method of networking the main game server computer to multiple player computers, comprising, (a) TCP/IP networking of a server computer to multiple player computers using 10/100 BaseT, Gigabit, or wireless Ethernet connections, (b) Installing and configuring a PC, Macintosh, or Linux-based version of game networking software on the main server computer, to allow for a total number of players, total timeout time, main server IP address, etc., (c) Giving the main game executable file on main server the same IP address as the server computer, (d) Giving each player game executable file on each machines the same IP address as the main server, (e) Giving each player game executable file a player number, and (f) Using game networking software to establish data communications sent via Lingo scripting language from the game executable file on the main server to game executable files on the player computers and vise-versa.

The method of input, tracking, and storing each player's personal and lead tracking information onto a database-ready, tab-or comma delimited file on each player CPU, comprising, (a) Player name and game icon selector graphical user interface screen(s), (b) Creating and opening a text (.txt) or database file, reading operating system's date, and time and adding this into the data text file, delimited by <TAB> or comma ASCII characters, (c) Input form 1 that included contact information (address, phone, e-mail, etc.), (d) Reading the fields from input form 1 and appending these to the data text file, (e) Input forms 2-4 which is customized based on the client's lead tracking information, reading these and appending them to the text file, and (f) Closing and saving each data file. The method of game playback and interactions between a main server and player computers, comprising, (a) Creation and Installation of two types of executable game files, one for main server and one for all player computers, (b) Looping custom animation digital video that plays on the main screen and all player screens according to claim 1, between each round of the game, (c) Triggering the simultaneous loading of the data entry and game icon selection screens on player computers according to claim 3, when the a game show host or hostess clicks anywhere on the main server screen that is playing the looping digital video or animation, or main automatically triggers start of the game when the log-in timer runs out, and (d) Sending all player icons and names to the main CPU, main displaying all the player names and icons on large display device according to claim 1, and main sending a second start signal to all players to start the actual game play.

The method of in-game graphics display, looping animation between games, comprising, (a) Looping, custom animation or digital video that plays between the games according to claim 1 and 4, is compressed for highest resolution, full-motion delivery across a LAN via MPEG-1, MPEG-2, MPEG-4 or other video Codecs, and (b) All animations in lead entry forms according to claim 3 are also optimized for high resolution, full-motion delivery across LAN networks.

Appendix 1 provides an example set of pseudo code according to an embodiment of the present invention. Appendix 1 is not intended to be a compilable or executable portion of code, and is also not intended to be used in a standardized pseudo code checker or other utility. Appendix 1 is not a limiting example of the invention as many variations or entirely different structures or techniques (e.g., object oriented techniques) may be constructed by the ordinarily skilled artisan upon review of the present disclosure. Therefore, it should be understood that appendix 1 is provided merely as an example structure in which

[image]

[image]

[image]

[image]

[image]

[image]

[image]

[image]

[image]

[image]

[image]

[image]

[image]

[image]

Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A lead tracking system, comprising:
an application program;
a contact information retrieval program configured to retrieve and store user contact information; and
a start program configured to delay start of the application program until contact information has been retrieved by the contact information retrieval program.

2. The lead tracking system according to claim 1, wherein said application program comprises a main program and a set of at least one player program configured to operate in conjunction with the main program.

3. The lead tracking system according to claim 1, wherein said main program executes on a main CPU and each player program executes on a remote CPU networked to the main CPU.

4. The lead tracking system according to claim 1, wherein said application program is a multi-player game.

5. The lead tracking system according to claim 1, wherein:
said application program is a multi-player game having a main game executable program and a set of player executable programs; and
said main game executable program is configured to provide an overall main video output and coordinate game play occurring on the set of player executable programs.

6. The lead tracking system according to claim 5, further comprising a main video switch mechanism configured to direct at least one of the overall game video output and at least one local game video output of the player executable programs to a main display screen.

7. The lead tracking system according to claim 5, wherein each respective player executable program has a local game video output showing game play action from a perspective of a user of the player executable program.

8. The lead tracking system according to claim 1, wherein said start program comprises an animation that is output to at least one display screen until the start of the application program.

9. The lead tracking system according to claim 1, wherein said start program delays the start of the application program until at least one user has entered contact information via the contact information retrieval program.

10. The lead tracking system according to claim 9, wherein said user contact information includes a nickname used by the application program.

11. The lead tracking system according to claim 9, wherein said animation incorporates data about users who have entered at least some contact information.

12. The lead tracking system according to claim 1, further comprising a card reader interface coupled to the contact information retrieval program, wherein said contact information retrieval program is further configured to accept contact information read by the card reader.

13. The lead tracking system according to claim 1, further comprising a database coupled to the contact information retrieval program, wherein the contact information retrieval program is further configured to search and match, and update records in the database with contact information entered by a user.

14. The lead tracking system according to claim 1, further comprising:
a photo capture program configured to retrieve a digital photograph of at least one user;
wherein said application program is configured to retrieve each user's digital photograph and utilize it in at least one of the start program, the application program, direct marketing materials later sent to the user, and as an entry stored with the user's contact information.

15. The lead tracking system according to claim 14, wherein the digital photographs are converted to icons that are used by at least one of the start program and the application program.

16. The lead tracking system according to claim 14, wherein the digital photographs are animated and then used by at least one of the start program and the application program.

17. A lead tracking system, comprising:
a main computing device;
a set of remote user computing devices networked to the main computing device;
a video control processor coupled to each of the remote user computing devices and the main computing device and configured to select an output from one of the main computing device and at least one of the remote user computing devices as an output from the video control processor;
a contact information collection mechanism configured to collect and store contact information from users operating the remote user computing devices; and
a multi-user application program comprising a start program and a main program, and configured to run on the main computing device;
wherein the multi-user application program is configured to run the start program until each of the users operating the remote user computing devices enters contact information, and then run the main program.

18. The lead tracking system according to claim 17, wherein the main program is a multi-player game.

19. The lead tracking system according to claim 17, further comprising an operator input panel that accepts commands from an operator for at least one of a manual main program start, and selection of an output of the video control processor.

20. The lead tracking system according to claim 17, further comprising:
at least one imaging device configured to capture images of the users operating the remote user computing devices;
wherein at least one of the start program and application program are configured to utilize the captured images in outputs of the program.

21. The lead tracking system according to claim 20, further comprising a graphics processor configured to convert the captured images into at least one of icons and animations used in the outputs of the programs.

22. The lead tracking system according to claim 21, wherein said start program and application program are parts of a single executable program.

23. The lead tracking system according to claim 17, further comprising a lead card scanner of optical, magnetic, or infrared type that would interface with player computing device.

24. The lead tracking system according to claim 17, wherein the main and user computing devices are at least one of a desktop, laptop, palmtop, or any other hand-held, portable or static computing device.

25. A method of lead tracking, comprising the steps of:
playing a startup video on a main video monitor;
collecting and saving contact information from a set of users; and
initiating a multi-player game between at least the set of users after collecting said contact information.

26. The method of claim 25, wherein said step of initiating a multi-player game comprises starting a main game application on a main computing device and starting a player game on each of a set of user computing devices networked with the main computing device.

27. The method of claim 26, further comprising the step of outputting to at least one main monitor at least one of a video output from the main computing device and at least one of the user computing devices.

28. The method according to claim 25, further comprising the step of executing the multi-player game until one of a time out and achievement of a predetermined objective.

29. The method according to claim 25, further comprising the step of displaying results of the multi-player game.

30. The method according to claim 29, wherein said results include at least on piece of information from the collected contact information.

31. The method according to claim 25, further comprising the step of initiating a directed marketing promotion to at least one of the users based on information contained in the collected contact information.

32. The method according to claim 31, wherein the directed marketing promotion includes information about the multi-player game.

33. The method according to claim 32, wherein the directed marketing promotion information includes at least one of a player nickname, player score, name of the multi-player game, number of times the multi-player game was played, and venue where the multi-player game was played.

34. The method according to claim 33, wherein:
said method is embodied in a set of computer instructions stored on a computer readable media;
said computer instructions, when loaded into a computer, cause the computer to perform the steps of said method.

35. The method according to claim 25, wherein:
said method is embodied in a set of computer instructions stored on a computer readable media;
said computer instructions, when loaded into a computer, cause the computer to perform the steps of said method.

36. The method according to claim 35, wherein said computer instruction are compiled computer instructions stored as an executable program on said computer readable media.

37. The method according to claim 25, wherein said method is embodied in a set of computer readable instructions stored in an electronic signal.

38. The method according to claim 25, further comprising the steps of:
capturing an image of at least one of the users; and
displaying the captured image as part of at least one of the startup video and multi-player game.

39. The method according to claim 38, further comprising the step of:
processing the captured images to that they are turned into at least one of icons, caricatures, texture-maps, e-mail postcards, and animations; and
utilizing the processed images in at least one of the startup video and multi-player game.

40. A lead tracking device, comprising:
means for running a multi-player game;
means for collecting user contact information from each of a set of players before allowing the players to participate in the multi-player game; and
means for displaying one of an overall game output and at least one output from one of the player's perspective on a main monitor.

41. A method of public displaying a multi-player computer game, comprising the steps of:
(a) connecting a main computer server (CPU) to a local main monitor and to a main video processor;
(b) connecting each of individual player computers to a local player monitor and to the main video processor;
(c) switching, via the main video processor, inputs of a video wall between outputs of the main computer server and outputs of one of the individual player computers.

42. The method according to claim 41, wherein the connections between the main computer server and local main monitor and main video processor are made via a VGA signal splitter placed at a VGA output of the main computer server.

43. The method according to claim 41, wherein the connections between the individual player computers and their corresponding local player monitor and the main video processor are made via VGA signal splitters, one VGA signal splitter each placed at a VGA output of each of the individual player computers.

44. The method according to claim 41, wherein the connections between the individual player computers and the main video processor are made via a wireless communications link.

45. The method according to claim 41, wherein said step of connecting the main computer server comprises:
connecting the main computer server (CPU) to the main video processor via at least one of an RS232 and USB connection.

46. The method according to claim 41, wherein said video wall comprises one of a multi-cube video wall, plasma display wall, and other large video display device, connected to the main video processor via one of a component video output (RGB), VGA and S-video connections.

47. The method according to claim 41, further comprising steps of:
executing a multi-player game having a main program executed on the main computer server and individual player programs executed on the individual player computers;
coordinating the individual player programs with the main program via a network connecting the main computer server with each of the individual player computers;
retrieving contact information from each player at the individual player computers; and
delaying execution of at least one important portion of the main program until at least one of (1) each of the players has finished entering contact information, (2) a timeout occurs, and (3) a manual program start signal is received from an operator.

48. The method according to claim 47, further comprising the steps of:
capturing images of the players;
processing the captured images into at least one of texture-maps, caricatures, icons, e-mail postcards, and animations; and
using the processed images in at least one of the main program and individual player programs.

49. The method according to claim 47, wherein said network is a wireless network.

50. The method according to claim 47, wherein said network is a TCP/IP network using 10/100 BaseT, Gigabit, optical, or wireless Ethernet connections.

51. The method according to claim 41, wherein said main computer server executes one of a PC and Macintosh based game networking software configured to accept different numbers of players, variable timeout time, and main server IP address.

52. The method according to claim 41, comprising the steps of:
assigning a main game executable file on main server the same IP address as the server computer,
giving each player game executable file on each machines the same IP address as the main server,
giving each player game executable file a player number, and
establishing data communications using a multi-user server via Lingo scripting language or other game networking software via their scripting or coding languages (again, too specific about mentioning Lingo?) from the main program on the main server to individual player programs on the player computers and vise-versa.

53. The method according to claim 51, wherein said game networking software comprises a version of Macromedia Multi-user Server.

54. The method according to claim 51, wherein said game networking software comprises a version of RTIME Interactive Networking Engine.

55. The method according to claim 51, wherein said game networking software enables realtime, multiuser applications over the Internet or other broadband networks

56. A method of input, tracking, and storing of player's personal and lead tracking information onto a database-ready, tab or comma-delimited file on each player CPU, comprising the steps of:
(a) displaying a player name input and game icon selector graphical user interface screen;
(b) creating and opening a file;
(c) saving the player's name and selected icon in the file;
(d) reading a current date and time from an operating system and adding this into the file;
(e) displaying a first input form that includes contact information including at least one of address, phone, and email;
(f) reading fields from the first input form and appending data from the fields to the data text file;
(g) displaying a second input form which is customized based on a client's lead tracking information;
(h) reading fields of the second form and appending them to the text file; and
(i) closing and saving each data text file.

57. The method according to claim 56, wherein said customization comprises questions or selections regarding at least one of demographics, product use, planned purchases, planned hiring, current issues, and other marketing data items.

58. The method according to claim 56, wherein said file is a TAB or comma delimited ASCII file.

59. The method according to claim 56, wherein said file is a database file.

60. The method according to claim 56, further comprising the step of delaying execution of an application program until each of the forms have been read and appended to the file.

61. The method according to claim 58, wherein said application program is a multi-player game.

62. A method of game play back and interactions between a main server and player computers, comprising the steps of:
installing a main program on a main computer and one player program on each of multiple player programs;
looping custom animation digital video that plays on a main screen and all player screens between executions of the main program;
retrieving icon selections and data entry, including names, from users of the player computers;
triggering start of the main program when the game master sends a start signal;
sending all selected player icons and names to the main computer;
displaying all the player names and icons on large display device; and
sending a game start signal to all players to start actual game play.

63. The method according to claim 62, wherein said step of looping animation comprises:
(a) decompressing a custom animation or digital video that is compressed for highest resolution, full-motion delivery across a LAN via MPEG-2, MPEG-4 or other Codecs; and
(b) looping the custom animation or digital video between games.

64. The method according to claim 63, wherein the compressed custom animation video is optimized for high resolution, full motion delivery across LAN networks or the internet.

65. The method according to claim 62, wherein the user (player) interactions between main server and player computers, and game play can be via mouse, keyboard, touch-screens, joysticks, or any similar analog or digital input device.
